(19) United States
(12) Patent Application Publication
(10) Pub. No.: US 2019/0039350 A1
(43) Pub. Date: Feb. 7, 2019

(54) Application of Carbon Nanotube Assemblies to Preparation of Nanocarbon Impact-Resistant Material and Preparation Method of Nanocarbon Impact-Resistant Material

(71) Applicant: Suzhou Institute of Nano-Tech and Nano-Bionics, Chinese Acadmey of Sciences, Suzhou (CN)

(72) Inventors: Dongmei Hu, Suzhou (CN); Qingwen Li, Suzhou (CN)

(21) Appl. No.: 16/072,376

(22) PCT Filed: Jan. 9, 2017
(86) PCT No.: PCT/CN2017/070627

§ 371 Date: Jul. 24, 2018

(30) Foreign Application Priority Data
Jan. 29, 2016 (CN) 201610064733.0
Jan. 29, 2016 (CN) 201610064973.0
Jan. 29, 2016 (CN) 201610064974.5

(51) Int. Cl. B32B 9/00; B32B 1/08; B32B 9/04; C01B 32/174; B32B 37/10; B32B 27/12

(52) U.S. Cl. CPC B32B 9/007; B32B 1/08; B32B 9/047; C01B 32/174; B32B 37/10; B32B 2307/54; B32B 2307/72; B32B 2571/02; C01B 2202/32; C01B 2202/36; B32B 27/12

(57) ABSTRACT

The invention discloses the application of carbon nanotube assemblies to the preparation of a nanocarbon impact-resistant material. The carbon nanotube assembly is a macrostructure provided with at least one continuous surface, a plurality of carbon nanotubes are densely distributed in the continuous surface, and at least partial segments of at least part of the multiple carbon nanotubes continuously extend in the continuous surface. The invention further discloses a preparation method of the nanocarbon impact-resistant material. The nanocarbon impact-resistant material has an excellent protection effect, has the advantages of being light, good in flexibility, wide in tolerable temperature range, capable of being bent freely, good in fitness, breathable, adaptable to heat-moisture balance of human bodies, good in wearing comfort and the like, and can be widely applied to bullet-proof materials, stab-proof materials and explosion-proof materials.

### BACKGROUND OF THE INVENTION

### Technical Field

The application relates to impact-resistant materials, in particular to the application of carbon nanotube assemblies to the preparation of a nanocarbon impact-resistant material such as an explosion-proof material, a bullet-proof material and a stab-proof material, and a preparation method of the nanocarbon impact-resistant material.

### Description of Related Art

Impact-resistant materials including explosion-proof materials, stab-proof materials, bullet-proof materials and the like are widely used in the weapon field, the chemical field, the traffic field, the aerospace field and other fields. Traditional impact-resistant materials mainly include metal materials, high molecular materials, ceramic materials and the like. Although the metal materials have good impact resistance through shape and structure design, the metal materials are bulky in structure and all rigid and consequentially can severely affect the flexibility of individual movement in use. Impact-resistant materials based on high molecular materials are mainly made of ultra-high molecular weight polyethylene (UHMWPE) fibers, polyarmide fibers, PBO fibers and the like. Although compared with the rigid impact-resistant materials made of metal and ceramic, these impact-resistant materials have the advantages of low weight and the like, these impact-resistant materials still have many defects, for example, the UHMWPE fibers are not resistant to heat and have the maximum tolerable temperature below 120° C.; the polyarmide fibers are not resistant to ultraviolet light or moisture; and the density of these high molecular materials is still relatively high. Therefore, these materials cannot meet the application requirements in certain fields, for example, when these impact-resistant materials are used as individual protection materials, protection structures formed by these high molecular impact-resistant materials are heavy, thick, poor in wearing comfort and non-breathable and consequentially affect the flexibility of individual movement.

In consideration of the defects of the traditional impact-resistant materials, researchers have put forwards various improvement schemes. For example, the patent with the application No. CN101218480B discloses a fabric matrix formed by a high-tenacity fiber net, wherein a bonding layer and a rubber layer are attached to the matrix once, and a plurality of these units are stacked to form a flexible stab-proof composite material; however, this stab-proof composite material is complex in structure, poor in processability and not suitable for batch preparation. According to the patent with the application No. US2004/0048536A1, a certain quantity of solid hard particulate matter is attached to the surface of high-performance fiber fabric to decrease the penetration depth of cutters. According to the patent with the application No. US20070105471, the surface of aramid fiber is coated with inorganic particles to improve the stab resistance of the material; however, the structure is made harder, and the wearing comfort is decreased. According to the patent with the application No. CN102058188B, nano particles and high-performance fiber fabric are compounded and then compounded with thermoplastic resin, in this way, the impact resistance can be greatly improved, the weight is effectively reduced, and the softness of the material is hardly changed. According to the patent with the application No. CN100567606A, carbon nanotubes are dissolved in adhesives and then smeared on UHMWPE fibers, in this way, the heat resistance, the creep property and the mechanical strength of UHMWPE can be effectively improved. However, due to the immature preparation technique of nanomaterials, in the scheme mentioned above, only a small quantity of nanomaterials can be added into the adhesives on the surfaces of the materials to improve the bullet-proof property, the dispersion uniformity of the nanomaterials in the adhesives and the stacking form and distribution condition of the nanomaterials on the surface of high-performance fibers all have an influence on the bullet-proof property of the materials, but all these factors are hard to control. In addition, the bullet-proof materials prepared through the method are still hard, rigid, high in density and weight, poor in fitness with human bodies and wearing comfort and can still severely affect the movement flexibility of human bodies.

### BRIEF SUMMARY OF THE INVENTION

To overcome the defects of the prior art, the application mainly aims to provide the application of carbon nanotube assemblies to the preparation of an impact-resistant material and a preparation method of the impact-resistant material.

According to the technical scheme adopted by the application to achieve the above aim:

One embodiment of the application provides the application of carbon nanotube assemblies to the preparation of a nanocarbon impact-resistant material. The carbon nanotube assembly is a macrostructure provided with at least one continuous surface. A plurality of carbon nanotubes are densely distributed in the continuous surface, and at least partial segments of at least part of the multiple carbon nanotubes continuously extend in the continuous surface.

In certain embodiments, graphene materials or other materials can be compounded on the surface and/or the interior of the carbon nanotube assembly.

One embodiment of the application provides a preparation method of the nanocarbon impact-resistant material. The preparation method comprises the steps: providing multiple carbon nanotubes, and closely gathering the multiple carbon nanotubes to form the carbon nanotube assembly, wherein the carbon nanotube assembly is a macrostructure provided with at least one continuous surface, and at least partial segments of at least part of the multiple carbon nanotubes continuously extend in the continuous surface.

In certain embodiments, graphene materials or other materials can be compounded on the surface and/or the interior of the carbon nanotube assembly.

In the embodiment mentioned above, the nanocarbon impact-resistant material formed by the carbon nanotube assembly can absorb a large quantity of impact energy by means of the hollow structure of the carbon nanotubes; when a load is applied to the material, the material absorbs energy through changes of the microstructure between the carbon nanotubes, such as fractures and crushes of the carbon nanotubes, and destroy of the overlap joint between the carbon nanotubes, and thus an excellent protection effect is achieved; and meanwhile, the nanocarbon impact-resistant material has the advantages of being light, good in flexibility, wide in tolerable temperature range (about from the liquid nitrogen temperature to 500° C.), capable of being bent freely, good in fitness, breathable, adaptable to heat-moisture balance of human bodies, good in wearing comfort and the like, and can be widely applied to the preparation of bullet-proof materials, stab-proof materials, explosion-proof materials and the like.

Furthermore, one embodiment of the application provides the application of carbon nanotube assemblies to the preparation of a stab-proof composite material. The carbon nanotube assembly comprises a two-dimensional surface macrostructure formed by a plurality of closely-gathered carbon nanotubes.

Furthermore, one embodiment of the application provides a stab-proof composite material comprising:

at least one carbon nanotube assembly, wherein the carbon nanotube assembly comprises a carbon nanotube film formed by a plurality of closely-gathered carbon nanotubes; and

soft base cloth, wherein the surface of at least one side of the soft base cloth is fixedly covered with at least one carbon nanotube film.

Preferably, the carbon nanotube assembly comprises a plurality of basic units which are distributed in an oriented mode, and the multiple basic units are densely distributed in one continuous surface in parallel, so that the carbon nanotube assembly is of a macro-ordered and micro-disordered form, and the continuous surface is a plane or a curved surface. Wherein, each basic unit comprises a two-dimensional surface structure formed by a plurality of disorderly-interwoven carbon nanotubes.

In certain embodiments, a plurality of carbon nanotube continuums are continuously gathered on the continuous surface and then compacted, and then the multiple basic units are formed; and each carbon nanotube continuum is formed by a plurality of disorderly-interwoven carbon nanotubes and is of a closed, semi-closed or open two-dimensional or three-dimensional spatial structure before being compacted.

Furthermore, the carbon nanotube continuums are prepared through the floating catalytic cracking method.

One embodiment of the application further provides a stab-proof structure. The stab-proof structure comprises a plurality of subunits which are arranged in a stacked mode, and each subunit comprises the stab-proof composite material.

One embodiment of the application further provides a preparation method of the stab-proof composite material. The preparation method of the stab-proof composite material comprises the steps:

continuously gathering a plurality of carbon nanotube continuums on one continuous plane or one continuous curved surface and then compacting the carbon nanotube continuums to form a plurality of oriented basic units, and closely arranging the multiple basic units to form the filmy carbon nanotube assembly, wherein each carbon nanotube continuum is formed by a plurality of disorderly-interwoven carbon nanotubes and is of a closed, semi-closed or open two-dimensional or three-dimensional spatial structure before being compacted;

fixedly arranging the carbon nanotube assemblies on the surface of the soft base cloth in a covering mode, so that the stab-proof composite material is formed.

One embodiment of the application further provides another preparation method of the stab-proof composite material. The preparation method of the stab-proof composite material comprises the steps: continuously gathering a plurality of carbon nanotube continuums on the surface of the soft base cloth and then compacting the carbon nanotube continuums to form a plurality of oriented basic units, and densely arranging the multiple basic units to form a filmy carbon nanotube assembly, so that the stab-proof composite material is formed, wherein each carbon nanotube continuum is formed by a plurality of disorderly-interwoven carbon nanotubes and is of a closed, semi-closed or open two-dimensional or three-dimensional spatial structure before being compacted.

In the embodiment mentioned above, the carbon nanotube assembly, particularly the soft carbon nanotube film, is combined with the soft base cloth, and particularly the soft carbon nanotube film is attached to the surface of high-performance fiber fabric to form the stab-proof composite material; the stab-proof composite material can effectively blunt cutter points, decrease the invasion depth of cutters, effectively disperse and absorb the kinetic energy of the cutters, effectively restrain movement of high-performance fibers, and decrease the nonuniformity in the surface of the fiber fabric; and meanwhile, the stab-proof composite material is light in structure and good in flexibility, does not affected the movement of human bodies after being worn, and has excellent environmental tolerability such as the excellent heat resistance, ultraviolet resistance and moisture environment resistance.

Furthermore, one embodiment of the application provides the application the carbon nanotube assemblies in the preparation of a bullet-proof composite material.

Furthermore, one embodiment of the application provides a bullet-proof composite material. The bullet-proof composite material comprises:

at least one carbon nanotube assembly, wherein the carbon nanotube assembly comprises a two-dimensional surface macrostructure formed by a plurality of closely-gathered carbon nanotubes; and

fabric, wherein the surface of at least one side of the fabric is covered with the carbon nanotube assemblies.

In certain embodiments, the carbon nanotube assembly comprises a plurality of basic units which are distributed in an oriented mode, wherein each basic unit comprises a two-dimensional surface structure formed by a plurality of interwoven carbon nanotubes.

In certain embodiments, the multiple basic units are densely arranged in one continuous surface in parallel, so that the carbon nanotube assembly is of a macro-ordered and micro-disordered form.

In certain embodiments, a plurality of carbon nanotube continuums are continuously gathered on the continuous surface and then compacted to form the multiple basic units. Wherein, the carbon nanotube continuums are prepared through the floating catalytic cracking method.

Wherein, the fabric is high-performance fiber fabric preferably.

One embodiment of the application provides a preparation method of the bullet-proof composite material. The preparation method of the bullet-proof composite material comprises the followings steps:

continuously gathering a plurality of carbon nanotube continuums on one continuous surface and then compacting the carbon nanotube continuums to form a plurality of oriented basic units, and closely arranging the multiple basic units to form the carbon nanotube assembly with the two-dimensional surface macrostructure, wherein each carbon nanotube continuum is formed by a plurality of disorderly-interwoven carbon nanotubes and is of a closed, semi-closed or open two-dimensional or three-dimensional spatial structure before being compacted;

fixedly attaching the carbon nanotube assemblies to the surface of the fabric, so that the bullet-proof composite material is formed.

In the embodiment mentioned above, the nanocarbon impact-resistant material mainly formed by the carbon nanotube assemblies is compounded with the fabric and particularly with the high-performance fiber fabric to form the bullet-proof composite material; the bullet-prof composite material can absorb a large quantity of impact energy by means of the hollow structure of the carbon nanotubes; when a load is applied to the material, the material absorbs energy by means of changes of the microstructure between the carbon nanotubes, such as fractures and crushes of the carbon nanotubes and destroy of the overlap joint between the carbon nanotubes, and thus an excellent protection effect is achieved; and meanwhile, the bullet-proof composite material of the application has the characteristics of being soft, small in density (smaller than 1 g/cm³), excellent in bullet-proof performance (efficient bullet deformation and energy absorbability), high in impact resistance, excellent in heat resistance (can be used at the high temperature of 400° C. in a short time and can be used at the high temperature of 200° C. in a long time), and capable of fitting with any curved surface of human bodies.

### BRIEF DESCRIPTION OF THE SEVERAL VIEWS OF THE DRAWINGS

For a clear illustration of the embodiments of the application or the technical scheme of the prior art, a brief description of the drawings required for the illustration of the embodiments of the application or the technical scheme of the prior art is given as follows. Obviously, the drawings in the following description are only used for certain embodiments of the application, and for those ordinarily skilled in the field, other drawings can also be obtained according to these drawings without creative work.

FIG. 1 is a diagram of the pressing treatment of a nanocarbon film by means of a hot press in one typical embodiment of the application.

FIG. 2 is a picture of a nanocarbon impact-resistant material film in one typical embodiment of the application.

FIG. 3 is a TEM picture of the nanocarbon impact-resistant material film in one typical embodiment of the application.

FIG. 4 is a TEM picture of carbon nanotubes contained in the nanocarbon impact-resistant material film in one typical embodiment of the application.

FIG. 5a is a structural diagram of a nanocarbon impact-resistant material based on orthogonal overlapping in one typical embodiment of the application.

FIG. 5b is a structural diagram of nanocarbon impact-resistant material based on multi-angle overlapping in one typical embodiment of the application.

### DETAILED DESCRIPTION OF THE INVENTION

In one aspect, the embodiment of the application provides the application of carbon nanotube assemblies to the preparation of an impact-resistant material, particularly a nanocarbon impact-resistant material. The carbon nanotube assembly is a macrostructure provided with at least one continuous surface, a plurality of carbon nanotubes are densely distributed in the continuous surface, and at least partial segments of at least part of the multiple carbon nanotubes continuously extend in the continuous surface.

‘Dense distribution’ mentioned above refers to at least one or the combination of multiple of cross distribution, interwoven distribution, intertwined distribution, parallel distribution or other proper distribution forms.

In certain embodiments, the carbon nanotube assembly is a porous assembly formed by a plurality of closely-gathered carbon nanotubes.

‘Close gathering’ mentioned above refers to ordered or disordered crossing, disordered interweaving, ordered or disordered intertwining, or other proper gathering forms.

Or in certain embodiments, the carbon nanotube assembly can also comprise a plurality of oriented carbon nanotubes which are densely distributed, for example, the carbon nanotube assembly is composed of a super-aligned carbon nanotube array.

In certain embodiments, the carbon nanotube assembly comprises a two-dimensional surface structure formed by a plurality of densely-gathered carbon nanotubes. For example, the carbon nanotube assembly can be in the form of a carbon nanotube layer or a self-support carbon nanotube film.

In certain embodiments, the carbon nanotube assembly comprises a two-dimensional surface structure formed by a plurality of interwoven carbon nanotubes. Wherein, the interweaving form can be ordered or disordered.

In certain embodiments, the nanocarbon impact-resistant material comprises at least two carbon nanotube assemblies which are arranged in a stacked mode, wherein each carbon nanotube assembly is in the form of a two-dimensional surface macrostructure.

In certain embodiments, the carbon nanotube assembly comprises a plurality of basic units which are arranged in an oriented mode, wherein each basic unit comprises a plurality of interwoven carbon nanotubes such as a two-dimensional surface formed by disorderly-interwoven carbon nanotubes.

In certain preferred embodiments, the nanocarbon impact-resistant material comprises at least two carbon nanotube assemblies which are arranged in a stacked mode, wherein at least one carbon nanotube assembly comprises a plurality of basic units which are distributed in an oriented mode in the first direction, the other carbon nanotube assembly comprises a plurality of basic units which are distributed in an oriented mode in the second direction, and the included angle between the first direction and the second direction is 0-180 degrees. Furthermore, the included angle between the first direction and the second direction is not 0 degree or 180 degrees and can be any proper angle within the range of 45-135 degrees.

In certain preferred embodiments, the multiple basic units are densely distributed in at least one continuous surface in parallel, and thus the carbon nanotube assembly is in a macro-ordered form.

Furthermore, the multiple carbon nanotubes in each basic unit are interwoven disorderly, and thus the carbon nanotube assembly is in a micro-disordered form. The inventor accidentally realizes that compared with nanocarbon impact-resistant materials formed by carbon nanotubes gathered in other modes, the nanocarbon impact-resistant material which is of the special macro-ordered and micro-disordered structure has more advantages in impact resistance and in other aspects. The possible reason for this is that, on the one hand, the nanocarbon impact-resistant material of the special structure can absorb a large quantity of impact energy through the unique structure of the carbon nanotubes, and on the other hand, as compact networks and abundant interfaces are formed between the carbon nanotubes, the carbon nanotubes can be fully matched with one another, and thus the nanocarbon impact-resistant material has excellent impact resistance.

In certain preferred embodiments, each basic unit comprises a two-dimensional surface structure which is formed after carbon nanotube continuums are deposited on at least one continuous surface and compacted, and each carbon nanotube continuum is formed by a plurality of interwoven carbon nanotubes and is of a closed, semi-closed or open two-dimensional or three-dimensional spatial structure before being compacted.

Furthermore, the carbon nanotube continuums are prepared through the chemical vapor deposition method and particularly through the floating catalytic cracking method. In certain embodiments, each carbon nanotube continuum is in the shape of a closed or open cylinder formed by a plurality of disorderly-interwoven carbon nanotubes and has a certain length, and the strip-shaped basic units can be formed after the carbon nanotube continuums are deposited on a certain matrix and compacted.

More specifically, certain existing bibliographies, such as P279, Issue 304, 2004, Science, can serve as references for the production technique of the carbon nanotube continuums. In certain typical cases, a preparation method of the carbon nanotube continuums comprises the following steps:

S1, heating a reaction furnace to the temperature of 1100-1600° C., keeping the temperature stable, and injecting carrier gas into the reaction furnace;

S2, injecting a liquid-phase carbon source into the reaction furnace through a carbon source injection pump, and then the liquid-phase carbon source evenly entering a carbon source injection tube core of a carbon source injection tube after sequentially passing through a carbon source delivery tube and a flow limiting part;

S3, gasifying the liquid-phase carbon source;

S4, forming the carbon nanotube assembly after the gasified carbon source is carried by the carrier gas to reach the high-temperature region of the reaction furnace.

Wherein, the liquid-phase carbon source can be the mixed solution of ethyl alcohol, ferrocene and thiophene, for example, the mass percent of ethyl alcohol is 90-99.9%, the mass percent of ferrocene is 0.1-5%, and the mass percent of thiophene is 0.1-5%. Wherein, the carrier gas is the mixed gas of hydrogen and nitrogen or the mixed gas of hydrogen and inert gas, for example, the volume percent of hydrogen can be 1-100%, the inert gas is argon or helium, and the gas flow of the carrier gas is 1-15 L/min.

In certain embodiments, a plurality of carbon nanotube continuums are continuously deposited on at least one continuous surface and then compacted, so that the multiple basic units are formed.

Preferably, the longitudinal peripheries of every two adjacent basic units are spaced from each other by a certain distance, or are next to each other or overlap with each other. Furthermore, the distance between every two adjacent basic units is minimized so that the two adjacent basic units can be better matched with or supported by each other, and accordingly, the reliability and impact strength of the nanocarbon impact-resistant material are further improved.

Furthermore, the continuous surface is a plane or a curved surface.

In certain embodiments, when the nanocarbon impact-resistant material comprises at least two carbon nanotube assemblies (also regarded as carbon nanotube films) which are arranged in a staggered mode and are each of a two-dimensional surface macrostructure, every two adjacent carbon nanotube assemblies can be directly bonded through cold pressing or hot pressing. Wherein, as the carbon nanotubes have the characteristic of large specific surface area, all the carbon nanotube assemblies can be bonded firmly, the environmental weatherability of the nanocarbon impact-resistant material is improved, and certain problems caused by adoption of binding agents are avoided.

Of course, in certain embodiments, when the nanocarbon impact-resistant material comprises at least two carbon nanotube assemblies (also regarded as carbon nanotube films) which are arranged in a staggered mode and are each of a two-dimensional surface macrostructure, a binding material layer can also be arranged between every two adjacent carbon nanotube assemblies.

In certain embodiments, when the nanocarbon impact-resistant material comprises at least two carbon nanotube assemblies (also regarded as carbon nanotube films) which are arranged in a staggered mode and are each of a two-dimensional surface macrostructure, shear thickening fluid can also be injected between every two adjacent carbon nanotube assemblies.

In certain preferred embodiments, graphene is further distributed on the surface and/or the interior of the carbon nanotube assembly.

For example, at least one carbon nanotube in at least one carbon nanotube assembly is covered with a graphene sheet.

Or, for example, at least one graphene sheet is connected between at least two carbon nanotubes in the carbon nanotube assembly in an overlapping mode.

Or, for example, the nanocarbon impact-resistant material further comprises the assembly of a plurality of graphene sheets, and the assembly of the multiple graphene sheets is fixedly connected with at least one carbon nanotube assembly.

Or, for example, at least one carbon nanotube assembly and at least one assembly of multiple graphene sheets are of a two-dimensional surface macrostructure and are arranged in a stacked mode.

In the embodiment mentioned above, the carbon nanotubes and graphene are compounded, and stress waves can be dispersed by means of the structural characteristic of a large graphene sheet layer, so that impact energy borne by the impact-resistant material in unit area is reduced, and accordingly, the protection effect is further improved.

In the embodiment mentioned above, the tube diameter of the carbon nanotubes can be 2 nm-100 nm, and the carbon nanotubes can be any type or the combinations of multiple types of single-wall carbon nanotubes, double-wall carbon nanotubes and multi-wall carbon nanotubes.

In certain embodiments, when the carbon nanotube assembly is of a two-dimensional surface macrostructure such as a self-support carbon nanotube film, the stress of the carbon nanotube film is equal to or higher than 10 MPa, the elongation of the carbon nanotube film is equal to or higher than 2%, the absolute value of the difference between the tensile stress in the length direction and the tensile stress in the width direction is smaller than or equal to 20% of the tensile stress in the length direction or in the width direction, and the absolute value of the difference between the breaking elongation in the length direction and the breaking elongation in the width direction is smaller than or equal to 10% of the breaking elongation in the length direction or in the width direction.

In certain embodiments, the carbon nanotube assembly is provided with a porous structure, the pore diameter of pores of the porous structure is 10 nm-200 nm, and the porosity of the porous structure is 10%-60%. Due to the existence of the porous structure, the carbon nanotube assembly has good breathability on the premise that the mechanical property of the carbon nanotube assembly is not severely affected.

In certain embodiments, the nanocarbon impact-resistant material is of a soft filmy or sheet structure on the whole.

Furthermore, the thickness of the nanocarbon impact-resistant material is 1-100 μm and preferably is 5-15 μm.

Furthermore, the surface density of the nanocarbon impact-resistant material is 2-20 g/m² and preferably is 5-10 g/m².

Furthermore, the tensile strength of the nanocarbon impact-resistant material is over 10 MPa, and the modulus of the nanocarbon impact-resistant material is over 10 GPa.

Furthermore, the tensile strength of the nanocarbon impact-resistant material is over 90 Mpa and preferably is over 200 MPa, and the modulus of the nanocarbon impact-resistant material is over 30 Gpa and preferably is over 60 GPa.

Furthermore, the tolerable temperature the nanocarbon impact-resistant material ranges from the liquid nitrogen temperature to 500° C.

In another aspect, the embodiment of the application provides an impact-resistant structure comprising any of the nanocarbon impact-resistant materials mentioned above.

In certain embodiments, the impact-resistant structure further comprises a matrix bonded with the nanocarbon impact-resistant material, wherein the matrix can be hard or soft, and when the impact-resistant structure is used for physical protection, the matrix is preferably a soft breathable matrix.

In another aspect, the embodiment of the application provides a preparation method of the nanocarbon impact-resistant material. The preparation method of the nanocarbon impact-resistant material comprises the steps: providing a plurality of carbon nanotubes, and closely gathering the multiple carbon nanotubes to form the carbon nanotube assembly, wherein the carbon nanotube assembly is of a macrostructure provided with at least one continuous surface, and at least partial segments of at least part of the multiple carbon nanotubes continuously extend in the continuous surface.

In certain embodiments, the preparation method comprises the steps: gathering at least one carbon nanotube continuum on one continuous surface under the effect of the Vander Wale force between the carbon nanotubes, and then compacting the carbon nanotube continuums, so that the carbon nanotube assembly is formed, wherein each carbon nanotube continuum is formed by a plurality of interwoven carbon nanotubes and is of a closed, semi-closed or open two-dimensional or three-dimensional spatial structure before being compacted.

Furthermore, multiple carbon nanotube continuums can be continuously gathered on one continuous surface and then compacted, so that the carbon nanotube assembly comprising a plurality of basic units distributed in an oriented mode is formed, wherein each basic unit comprises a two-dimensional surface structure formed by at least one carbon nanotube continuum.

Furthermore, multiple basic units can be densely arranged in one continuous surface in parallel, so that the carbon nanotube assembly is in a macro-ordered form.

The continuous surface mentioned above can be provided by certain matrixes including, but not limited to, an arc-shaped receiving surface of a roller, a polymer film and fabric. Therefore, the continuous surface can be a plane or a curved surface.

Furthermore, the longitudinal peripheries of every two adjacent basic units can be spaced from each other, or be next to each other or overlap with each other.

Furthermore, each carbon nanotube continuum is formed by a plurality of disorderly-interwoven carbon nanotubes, so that the formed carbon nanotube assembly is in a micro-disordered form.

Furthermore, the carbon nanotube continuums can be prepared through the floating catalytic cracking method.

In certain embodiments, the preparation method can further comprise the steps:

providing at least two carbon nanotube assemblies each of a two-dimensional surface macrostructure;

and arranging the carbon nanotube assemblies in a stacked mode.

Furthermore, at least one of at least two carbon nanotube assemblies comprises a plurality of basic units which are distributed in an oriented mode in the first direction, the other carbon nanotube assembly comprises a plurality of basic units which are distributed in an oriented mode in the second direction, and the included angle between the first direction and the second direction is 0-180 degrees and particularly is 45-135 degrees, for example the included angle preferably is 45 degrees, 90 degrees, 135 degrees and the like.

Furthermore, pressure can be applied to at least two carbon nanotube assemblies to combine the carbon nanotube assemblies into an integrated structure.

Furthermore, at least two carbon nanotube assemblies can be bonded into an integrated structure through binding agents.

Furthermore, the preparation method can further comprise the step: arranging a binding material layer between every two adjacent carbon nanotube assemblies or injecting shear thickening fluid between every two adjacent carbon nanotube assemblies.

Furthermore, the preparation method can comprise the step: completing compaction with or without binding agents and/or solvents. Wherein, the binding agents can be, but are not limited to, the substances mentioned above, and the solvents can be water, organic solvents (such as ethyl alcohol), or certain solutions containing inorganic matter or organic matter.

In certain embodiments, the preparation method can further comprise the step: hot-pressing the carbon nanotube assemblies to further improve the distribution compactness of the carbon nanotubes in the carbon nanotube assemblies.

Furthermore, the carbon nanotube assemblies can be hot-pressed at least through rollers or a plane press or through the rollers as well as the plane press.

Wherein, the hot-pressing temperature preferably can range from the indoor temperature to 300° C., and the hot-pressing pressure preferably can be 2-50 Mpa.

In certain preferred embodiments, the preparation method can further comprise the step: covering at least one carbon nanotube in at least one carbon nanotube assembly with graphene.

Furthermore, the preparation method can further comprise the step: bonding graphene with the multiple carbon nanotubes forming the carbon nanotube assemblies through at least one of cladding, infiltrating, soaking and spraying in the forming process of the carbon nanotube assemblies or after the carbon nanotube assemblies are formed.

In another aspect, the embodiment of the application provides the application of the carbon nanotube assemblies to the preparation of a stab-proof composite material.

Furthermore, the stab-proof composite material comprises:

at least one carbon nanotube assembly, wherein the carbon nanotube assembly comprises a carbon nanotube film formed by a plurality of closely-gathered carbon nanotubes; and

soft base cloth, wherein the surface of at least one side of the soft base cloth is fixedly coated with at least one carbon nanotube film.

‘Close gathering’ mentioned here is defined as mentioned above. For example, as one of the feasible schemes, the carbon nanotube assembly can also comprise a plurality of oriented carbon nanotubes which are densely distributed. For example, the carbon nanotube film can be composed of a super-aligned carbon nanotube array.

In certain embodiments, the multiple carbon nanotubes in the carbon nanotube assembly are interwoven to form the carbon nanotube film. Wherein, the interweaving form can be ordered interweaving or disordered.

In certain embodiments, the carbon nanotube assembly can be in the form of a self-support carbon nanotube film.

In certain preferred embodiments, the carbon nanotube assembly comprises a plurality of basic units which are distributed in an oriented mode, wherein each basic unit comprises a two-dimensional surface structure formed by a plurality of interwoven carbon nanotubes.

Furthermore, the multiple basic units are densely distributed in one continuous surface in parallel, so that the carbon nanotube assembly is in a macro-ordered form, and the continuous surface is a plane or a curved surface.

Furthermore, the multiple carbon nanotubes in each basic unit are interwoven disorderly, and thus the carbon nanotube assembly is in a micro-disordered form. The inventor accidentally realizes that compared with nanocarbon impact-resistant materials formed by carbon nanotubes gathered in other modes, the nanocarbon impact-resistant material which is of the special macro-ordered and micro-disordered structure has more advantages in impact resistance and in other aspects. The possible reason for this is that on the one hand, the nanocarbon impact-resistant material of the special structure can absorb a large quantity of impact energy through the unique structure of the carbon nanotubes, and on the other hand, as compact networks and abundant interfaces are formed between the carbon nanotubes, the carbon nanotubes can be fully matched with one another, and thus the nanocarbon impact-resistant material has excellent impact resistance.

In certain preferred embodiments, a plurality of carbon nanotube continuums are deposited on the continuous surface and then compacted, so that the multiple basic units are formed; and each carbon nanotube continuum is formed by a plurality of disorderly-interwoven carbon nanotubes and is of a closed, semi-closed or open two-dimensional or three-dimensional spatial structure before being compacted.

Furthermore, the carbon nanotube continuums are prepared through the chemical vapor deposition method and particularly through the floating catalytic cracking method. In certain embodiments, each carbon nanotube continuum is in the shape of a closed or open cylinder formed by a plurality of disorderly-interwoven carbon nanotubes and has a certain length, and the strip-shaped basic units can be formed after the carbon nanotube continuums are deposited on a certain matrix and compacted.

Wherein, the production technique, mentioned above, of the carbon nanotube continuums can be adopted.

Preferably, the longitudinal peripheries of every two adjacent basic units are spaced from each other by a certain distance, or are next to each other or overlap with each other. Furthermore, the distance between every two adjacent basic units is minimized so that the two adjacent basic units can be better matched with or supported by each other, and accordingly, the reliability and impact strength of the nanocarbon impact-resistant material are further improved.

In certain preferred embodiments, graphene is further distributed on the surface and/or the interior of the carbon nanotube assemblies.

For example, at least one carbon nanotube of at least one carbon nanotube assembly is covered with a graphene sheet.

Or, for example, at least one graphene sheet is connected between at least two carbon nanotubes in the carbon nanotube assembly in an overlapping mode.

Or, for example, the nanocarbon impact-resistant material further comprises the assembly of a plurality of graphene sheets, and the assembly of the multiple graphene sheets is fixedly connected with at least one carbon nanotube assembly.

Or, for example, at least one carbon nanotube assembly and at least one assembly of multiple graphene sheets are of a two-dimensional surface macrostructure and are arranged in a stacked mode.

In the embodiment mentioned above, the carbon nanotubes and graphene are compounded, and stress waves can be dispersed by means of the structural characteristic of a large graphene sheet layer, so that impact energy borne by the impact-resistant material in unit area is reduced, and accordingly, the protection effect is further improved.

In the embodiment mentioned above, the tube diameter of the carbon nanotubes can be 2-100 nm, and the carbon nanotubes can be any type or the combinations of multiple types of single-wall carbon nanotubes, double-wall carbon nanotubes and multi-wall carbon nanotubes.

Preferably, the content of the carbon nanotubes in the carbon nanotube assembly is over 99 wt %.

In certain embodiments, when the carbon nanotube assembly is of a two-dimensional surface macrostructure such as a self-support carbon nanotube film, the stress of the carbon nanotube film is equal to or higher than 10 MPa, the elongation of the carbon nanotube film is equal to or higher than 2%, the absolute value of the difference between the tensile stress in the length direction and the tensile stress in the width direction is smaller than or equal to 20% of the tensile stress in the length direction or the width direction, and the absolute value of the difference between the breaking elongation in the length direction and the breaking elongation in the width direction is smaller than or equal to 10% of the breaking elongation in the length direction or the width direction. Preferably, the thickness of the carbon nanotube film is smaller than or equal to that of the soft base cloth.

Furthermore, the carbon nanotube assembly is provided with a porous structure, the pore diameter of pores of the porous structure is 10 nm-200 nm, and the porosity of the porous structure is 10%-60%. Due to the existence of the porous structure, the carbon nanotube assembly has good breathability on the premise that the mechanical property of the carbon nanotube assembly is not severely affected.

Furthermore, the thickness of the carbon nanotube assemblies is 1-100 μm and preferably is 5-15 μm.

Furthermore, the surface density of the carbon nanotube assemblies is 2-20 g/m² and preferably is 5-10 g/m².

Furthermore, the tensile strength of the carbon nanotube assemblies is over 10 MPa, and the modulus of the carbon nanotube assemblies is over 10 GPa.

Furthermore, the tensile strength of the carbon nanotube assemblies is over 90 Mpa and preferably is over 200 MPa, and the modulus of the carbon nanotube assemblies is over 30 Gpa and preferably is over 60 GPa.

Furthermore, the tolerable temperatures of the carbon nanotube assemblies range from liquid nitrogen temperature to 500° C.

Preferably, the strength of high-performance fibers forming the soft base cloth is equal to or higher than 2.0 GPa, the modulus of the high-performance fibers is equal to or higher than 80 GPa, and the elongation of the high-performance fibers is 3-5%. Preferably, the soft base cloth is non-woven cloth, and the surface density of the non-woven cloth is 35-180 g/m².

In certain embodiments, the base cloth comprises UHMWPE unidirectional cloth or aramid unidirectional cloth.

In certain embodiments, the soft base cloth and the carbon nanotube assemblies are bonded through hot-pressing.

In certain embodiments, the soft base cloth and the carbon nanotube assemblies are bonded through binding agents. Wherein, the binding agents can be, but are not limited to, polyvinyl acetate (PVA) and silicone or polyethylene or polyurethane binding agents.

In certain embodiments, resin films are attached to the surface of the carbon nanotube assembly and/or the surface of the soft base cloth. Wherein, the resin films are made of epoxy, polyethylene or polyester compounds including, but not limited to, polypropylene (PP), polyethylene (PE), polyphenylene sulfide (PPS) and polyvinyl butyral (PVB).

In another aspect, the embodiment of the application provides a stab-proof structure. The stab-proof structure comprises a plurality of subunits which are arranged in a stacked mode, wherein each subunit comprises the stab-proof composite material.

Preferably, the stab-proof structure comprises N subunits, wherein N is an integral multiple of four.

In certain embodiments, in every two adjacent subunits, the basic units of the carbon nanotube assemblies in one subunit are arranged in an oriented mode in the first direction, the basic units of the carbon nanotube assemblies in the other subunit are arranged in an oriented mode in the second direction, the included angle between the first direction and the second direction is 0-180 degrees and preferably is 45-135 degrees.

In another aspect, the embodiment of the application provides a preparation method of the stab-proof composite material. The preparation method comprises the steps:

continuously gathering a plurality of carbon nanotube continuums on one continuous plane or one curved surface and compacting the carbon nanotube continuums to form a plurality of oriented basic units, and densely arranging the multiple basic units to form the filmy carbon nanotube assembly, wherein each carbon nanotube continuum is formed by a plurality of disorderly-interwoven carbon nanotubes and is of a closed, semi-closed or open two-dimensional or three-dimensional spatial structure before being compacted;

Fixedly arranging the carbon nanotube assemblies on the surface of the soft base cloth in a covering mode, so that the stab-proof composite material is formed.

The embodiment of the application further provides another preparation method of the stab-proof composite material. The preparation method comprises the steps: continuously gathering a plurality of carbon nanotube continuums on the surface of the soft base cloth and compacting the carbon nanotube continuums to form a plurality of oriented basic units, and densely arranging the multiple basic units to form the filmy carbon nanotube assembly, so that the stab-proof composite material is formed, wherein each carbon nanotube continuum is formed by a plurality of disorderly-interwoven carbon nanotubes and is of a closed, semi-closed or open two-dimensional or three-dimensional spatial structure before being compacted.

In certain embodiments, the carbon nanotube continuums are prepared through the floating catalytic cracking method specifically as mentioned above.

In certain embodiments, the preparation method further comprises the step: hot-pressing the soft base cloth and the carbon nanotube assemblies bonded with the soft base cloth.

In certain embodiments, as for the hot-pressing conditions, the temperature ranges from indoor temperature to 140° C., the pressure is 1-30 MPa, and the time is over 1 min.

For example, the hot-pressing process comprises:

the first stage for which the temperature is 110-120° C., the pressure is 1-4 MPa and the time is 10-30 min;

the second stage for which the temperature is 120-140° C., the pressure is 15-30 MPa and the time is 1-3 min.

In certain embodiments, as for the hot-pressing conditions, the temperature is the indoor temperature, the pressure is 1-30 MPa, and the time is 1-30 min.

The stab-proof composite material provided by the above embodiment of the application has the characteristics of being light, thin, excellent in stab resistance and suitable for batch preparation.

In another aspect, the embodiment of the application provides the application of the carbon nanotube assemblies to the preparation of a bullet-proof composite material. Wherein, the carbon nanotube assembly comprises a two-dimensional surface macrostructure formed by a plurality of closely-gathered carbon nanotubes.

Furthermore, the bullet-proof composite material comprises:

at least one carbon nanotube assembly, wherein the carbon nanotube assembly comprises the two-dimensional surface macrostructure formed by a plurality of closely-gathered carbon nanotubes; and

fabric, wherein the surface of at least one side of the fabric is covered with at least one carbon nanotube assembly.

In certain embodiments, the carbon nanotube assembly comprises a two-dimensional surface structure formed by a plurality of interwoven carbon nanotubes, wherein the interweaving form can be ordered or disordered.

In certain preferred embodiments, the carbon nanotube assembly comprises a plurality of basic units which are distributed in an oriented mode, wherein each basic unit comprises a two-dimensional surface structure formed by a plurality of interwoven carbon nanotubes.

Furthermore, the multiple basic units are densely distributed in one continuous surface in parallel, so that the carbon nanotube assembly is in a macro-ordered form.

The continuous surface mentioned above can be provided by certain matrixes including, but not limited to, an arc-shaped receiving surface of a roller, a polymer film and fabric. Therefore, the continuous surface can be a plane or a curved surface.

Furthermore, the multiple carbon nanotubes in each basic unit are interwoven disorderly, and thus the carbon nanotube assembly is in a micro-disordered form. The inventor accidentally realizes that compared with nanocarbon impact-resistant materials formed by carbon nanotubes gathered in other modes, the nanocarbon impact-resistant material which is of the special macro-ordered and micro-disordered structure has more advantages in impact resistance and other aspects. The possible reason for this is that on the one hand, the nanocarbon impact-resistant material of the special structure can absorb a large quantity of impact energy through the unique structure of the carbon nanotubes, and on the other hand, as compact networks and abundant interfaces are formed between the carbon nanotubes, the carbon nanotubes can be fully matched with one another, and thus the nanocarbon impact-resistant material has excellent impact resistance.

In certain preferred embodiments, a plurality of carbon nanotube continuums are deposited on the continuous surface and then compacted, so that the multiple basic units are formed.

Wherein, each carbon nanotube continuum is formed by a plurality of disorderly-interwoven carbon nanotubes and is of a closed, semi-closed or open two-dimensional or three-dimensional spatial structure before being compacted. Furthermore, the carbon nanotube continuums are prepared through the floating catalytic cracking method.

Wherein, certain typical carbon nanotube continuums are each in the shape of an open or closed cylinder formed by multiple disorderly-interwoven carbon nanotubes and have a certain length, and the strip-shaped basic units can be formed after the carbon nanotube continuums are deposited on a certain matrix and compacted.

More specifically, certain existing bibliographies can serve as references for the production technique of the carbon nanotube continuums, for example, the a single layer of multiple layers of carbon nanotube continuums can be grown by means of carbon source gas through catalyst pyrolysis, the carbon nanotube continuums are then gathered on a continuous plane or a curved surface (namely the continuous surface mentioned above) to form the carbon nanotube assembly, and the carbon nanotube assembly can be a self-support or non-self-support carbon nanotube film.

Furthermore, the production technique, mentioned above, of the carbon nanotube continuum can be adopted.

Preferably, the longitudinal peripheries of every two adjacent basic units are spaced from each other by a certain distance, or are next to each other or overlap with each other. Furthermore, the distance between every two adjacent basic units is minimized so that the two adjacent basic units can be better matched with or supported by each other, and accordingly, the reliability and impact strength of the nanocarbon impact-resistant material are further improved.

In certain embodiments, continuous carbon nanotube continuums can be prepared through the technique mentioned above and then are collected in a wound mode to form the carbon nanotube assembly (namely the carbon nanotube film) with the controllable thickness (preferably over l0 nm), the carbon nanotube film has the characteristics of being ordered macroscopically (having a high degree of orientation macroscopically) and disordered microcosmically (carbon nanotubes are in overlap joint on the same surface freely), and the thickness of the carbon nanotube film can be controlled from the nanoscale to the millimeter scale.

In certain embodiments, when two or more carbon nanotube continuums are arranged in a stacked mode, every two adjacent carbon nanotube assemblies can be directly bonded together through cold pressing or hot pressing. Wherein, as the carbon nanotubes have the characteristic of large specific surface area, all the carbon nanotube assemblies can be bonded firmly, the environmental weatherability of the carbon nanotube assemblies is improved, and certain problems caused by adoption of binding agents can be avoided.

Furthermore, in certain embodiments, a binding material layer can also be arranged between every two adjacent carbon nanotube assemblies.

Furthermore, in certain embodiments, shear thickening fluid can also be injected between every two adjacent carbon nanotube assemblies.

In certain preferred embodiments, graphene is further distributed on the surface and/or the interior of the carbon nanotube assemblies.

For example, at least one carbon nanotube of at least one carbon nanotube assembly is covered with a graphene sheet.

Or, for example, at least one graphene sheet is connected between at least two carbon nanotubes in the carbon nanotube assembly in an overlapping mode.

Or, for example, the nanocarbon impact-resistant material further comprises the assembly of a plurality of graphene sheets, and the assembly of the multiple graphene sheets is fixedly connected with at least one carbon nanotube assembly.

Or, for example, at least one carbon nanotube assembly and at least one assembly of multiple graphene sheets are of a two-dimensional surface macrostructure and are arranged in a stacked mode.

In the embodiment mentioned above, the carbon nanotubes and graphene are compounded, and stress waves can be dispersed by means of the structural characteristic of a large graphene sheet layer, so that impact energy borne by the impact-resistant material in unit area is reduced, and accordingly, the protection effect is further improved.

In certain embodiments, the thickness of the carbon nanotube continuums is 1-100 μm and preferably is 5-15 μm.

Furthermore, the surface density of the carbon nanotube continuums is 2-20 g/m² and preferably is 5-10 g/m².

Furthermore, the tensile strength of the carbon nanotube continuums is over 10 MPa, preferably is over 90 Mpa and particularly is over 200 MPa, and the modulus of the carbon nanotube continuums is over 10 GPa, preferably is over 30 GPa and particularly is over 60 GPa.

Furthermore, the tolerable temperature of the carbon nanotube continuums ranges from the liquid nitrogen temperature to 500° C.

In certain preferred embodiments, the carbon nanotube assembly is a carbon nanotube film, the strength of the carbon nanotube film in the orientation direction of the basic units of the carbon nanotube film is 50 MPa-12 GPa and preferably is 120 MPa-1 GPa, and the strength of the carbon nanotube film in the direction perpendicular to the orientation direction of the basic units is 30 MPa-10 GPa and preferably is 60 MPa-800 MPa.

In the embodiments mentioned above, the tube diameter of the carbon nanotubes can be 2 nm-100 nm, and the carbon nanotubes can be any type or the combinations of multiple types of single-wall carbon nanotubes, double-wall carbon nanotubes and multi-wall carbon nanotubes.

In certain embodiments, the carbon nanotube assembly is provided with a porous structure, the pore diameter of pores of the porous structure is 10 nm-200 nm, and the porosity of the porous structure is 10%-60%. Due to the existence of the porous structure, the carbon nanotube assembly has good breathability on the premise that the mechanical property of the carbon nanotube assembly is not severely affected.

In certain embodiments, the tensile strength of the monofilaments of the fabric is over 22 CN/dtex and preferably is over 35 CN/dtex.

In certain preferred embodiments, the fabric is high-performance fiber fabric, and the high-performance fiber fabric is non-woven fabric and/or interwoven fabric.

Wherein, the high-performance fibers forming the high-performance fiber fabric can be, but are not limited to, any type or the combination of more than two types of UHMWPE fibers, aramid fibers and poly-p-phenylene ben-zobisthiazole fibers.

Preferably, the surface density of the high-performance fiber fabric is 35-220 g/m² and preferably is 120-160 g/m².

In certain embodiments, the bullet-proof composite material comprises at least two layers of fabric arranged in a stacked mode and/or at least two carbon nanotube assemblies arranged in a stacked mode, and the carbon nanotube assemblies are filmy.

Furthermore, at least one carbon nanotube assembly is distributed between every two adjacent layers of fabric, and/or at least one layer of fabric is distributed between every two adjacent carbon nanotube assemblies.

In certain embodiments, the two adjacent layers of fabric are both non-woven fabric, and the included angle between the warp orientation direction of one layer of fabric and the warp orientation direction of the other layer of fabric is 0-180 degrees, for example, the included angle can be any proper angle ranging from 45 degrees to 135 degrees.

In certain embodiments, the orientation direction of the basic units in at least one carbon nanotube assembly distributed between the two adjacent layers of fabric is the same as the warp orientation direction of at least one layer of fabric, and the fabric is non-woven fabric.

In certain embodiments, the carbon nanotube assemblies are attached to the surfaces of the two opposite sides of at least one layer of fabric.

In certain embodiments, one layer of fabric is interwoven fabric, and the two filmy carbon nanotube assemblies distributed on the two sides of the fabric are structurally symmetrical.

In certain specific embodiments, if the high-performance fiber fabric is regarded as a structural unit A and the carbon nanotube assembly (particularly the carbon nanotube film) is regarded as a structural unit B.

The high-performance fiber fabric is non-woven fabric

The characteristics of A: multiple layers of non-woven fabric are alternately stacked in a 0/90 mode (as the warp orientations of every two adjacent layers of non-woven fabric are perpendicular, if the warp orientation of one layer of non-woven fabric A₀ is set as 0 degree, the warp orientation of the other layer of non-woven fabric A₉₀ is set as 90 degrees, and this is abbreviated as 0/90);

the characteristics of B: two or more carbon nanotube assemblies are stacked (as the orientations of the basic units of every two carbon nanotube assemblies are perpendicular, if the orientation of the basic units of one carbon nanotube assembly B₀ is set as 0 degree, the orientation of the basic units of the other carbon nanotube assembly B₉₀ is set as 90 degrees);

wherein, more than one layer of B is inserted into A in the mode that the orientation of A is the same as that of B (the orientation of any layer of non-woven fabric in A is the same as that of the basic units in any carbon nanotube assembly in B);

or, at least one layer of B is compounded on the surface of one side of A₀ and A₉₀, or the surfaces of both sides of A₀ and A₉₀, or the surface(s) of one side or both sides of A.

The high-performance fiber fabric is interwoven fabric

More than one layer of B (defined as mentioned above) is inserted into A (which can be formed by two stacked layers of interwoven fabric), or A (one layer of interwoven fabric) is inserted into B.

Wherein, Bs located on the upper surface and the lower surface of A need to be structurally symmetrical. For example, a B₀AB₉₀B₉₀AB₀ (sequentially stacked) unit structure or a B₀B₉₀AB₉₀B₀ unit structure can be formed.

In certain embodiments, the carbon nanotube assemblies and the fabric are tightly attached through vacuum treatment, cold-pressing treatment or hot-pressing treatment.

In certain embodiments, the carbon nanotube assemblies and the fabric are bonded through binding agents.

In certain embodiments, first binding agent molecules are distributed on the surface of the carbon nanotube assembly, and/or second binding agent molecules are distributed on the surface, matched with the carbon nanotube assembly, of the fabric; and the first binding agent molecules are identical with or different from the second binding agent molecules.

Another embodiment of the application provides a preparation method of the bullet-proof composite material. The preparation method of the bullet-proof composite material comprises the steps:

continuously gathering a plurality of carbon nanotube continuums on one continuous surface and compacting the carbon nanotube continuums to form a plurality of oriented basic units, and densely arranging the multiple basic units to form the carbon nanotube assembly provided with a two-dimensional surface macrostructure, wherein each carbon nanotube continuum is formed by a plurality of disorderly-interwoven carbon nanotubes and is of a closed, semi-closed or open two-dimensional or three-dimensional spatial structure before being compacted;

fixedly attaching the carbon nanotube assembly to the surface of the fabric, so that the bullet-proof composite material is formed.

Preferably, as mentioned above, the carbon nanotube continuums are prepared through the floating catalytic cracking method.

Furthermore, the continuous surface is a plane or a curved surface.

Furthermore, the preparation method can further comprise the step: completing compaction with or without binding agents and/or solvents. Wherein, the binding agents can be, but not limited to, the substances mentioned above. The solvents can be water, organic solvents (such as ethyl alcohol), or certain solutions containing inorganic matter or organic matter.

In certain embodiments, the preparation method can further comprise the step: hot-pressing the carbon nanotube assembly to further improve the distribution compactness of the carbon nanotubes.

Furthermore, the carbon nanotube assemblies can be hot-pressed at least through rollers or a plane press or through the rollers as well as the plane press.

Wherein, the hot-pressing temperature can preferably range from the indoor temperature to 300° C., and the hot-pressing pressure can be preferably 2-50 Mpa.

In certain preferred embodiments, the preparation method can further comprise the step: covering at least one carbon nanotube in at least one carbon nanotube assembly with graphene.

Furthermore, the preparation method can further comprise the step: bonding graphene with the multiple carbon nanotubes forming the carbon nanotube assemblies through at least one of cladding, infiltrating, soaking and spraying in the forming process of the carbon nanotube assemblies or after the carbon nanotube assemblies are formed.

In certain embodiments, the preparation method comprises the steps:

arranging at least two layers of fabric in a stacked mode to form a basic structural unit;

and covering the surface of at least one side of the basic structural unit with at least one carbon nanotube assembly, and/or inlaying at least one carbon nanotube assembly into the basic structural unit.

In certain embodiments, the fabric is non-woven fabric, and the orientation of the basic units in at least one carbon nanotube assembly is the same as the warp orientation of at least one layer of fabric.

In certain embodiments, the fabric is interwoven fabric, and the two carbon nanotube assemblies arranged the surfaces of the two sides of the basic structural unit in the covering mode are structurally symmetrical.

In certain embodiments, the preparation method comprises the step: injecting binding agents between the carbon nanotube assemblies and the surface of the fabric, so that the carbon nanotube assemblies and the fabric are bonded.

Wherein, the surface of the high-performance fiber fabric can be provided with certain binding agent molecules C.

Wherein, the surfaces of the carbon nanotube assemblies can be provided with or not provided with binding agent molecules D.

Wherein, the binding agent molecules C and the binding agent molecules D can be of the same type or different types, and the usability of any type of binding agent molecules should not be reduced after the binding agent molecules C and the binding agent molecules D are bonded.

In certain embodiments, the preparation method comprises the step: removing air between the fabric and the carbon nanotube assemblies through any method of vacuum treatment, hot pressing or cold pressing, so that the carbon nanotube assemblies are tightly attached to the fabric.

The bullet-proof composite material in the embodiment mentioned above has the characteristics of being low in density, light, thin, good in softness and environmental weatherability, excellent in bullet-proof performance, suitable for batch preparation and the like.

For a further understanding of the application, a detailed description of the application is given with several embodiments and accompanying drawings as follows. However, it should be understood that those skilled in the field can also achieve the application by properly improving the technological parameters according to the content of the description. What particularly needs to be pointed out is that all similar substitutes and modifications which can be easily obtained by those skilled in the field are within the scope of the application. The application has been described through the preferred embodiments, and relevant personnel can easily achieve and apply the application technique through modifications or proper changes and combinations of the application without deviating from the content, spirit and scope of the application.

First Embodiment: the preparation technique of the nanocarbon impact-resistant material in the first embodiment comprises the following steps:

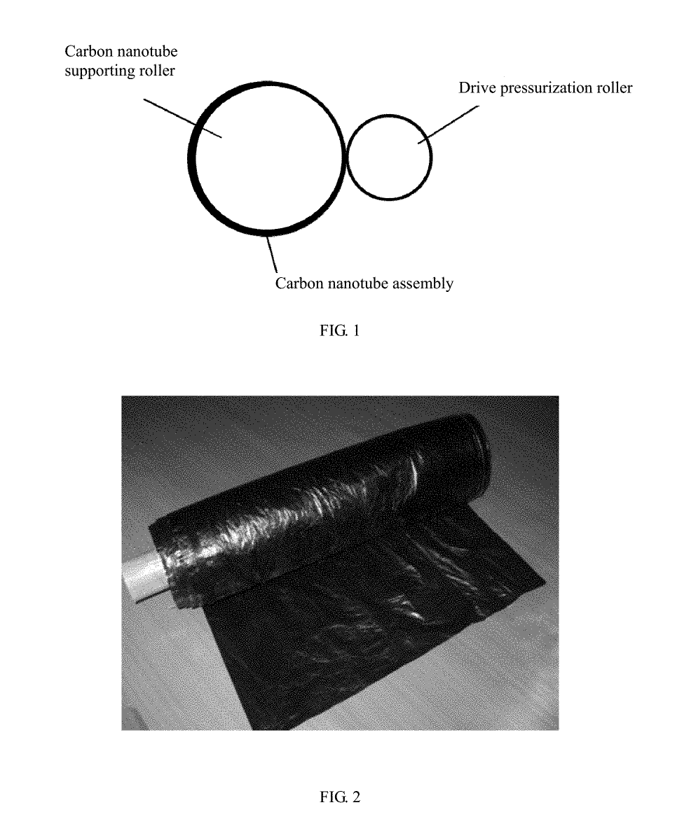

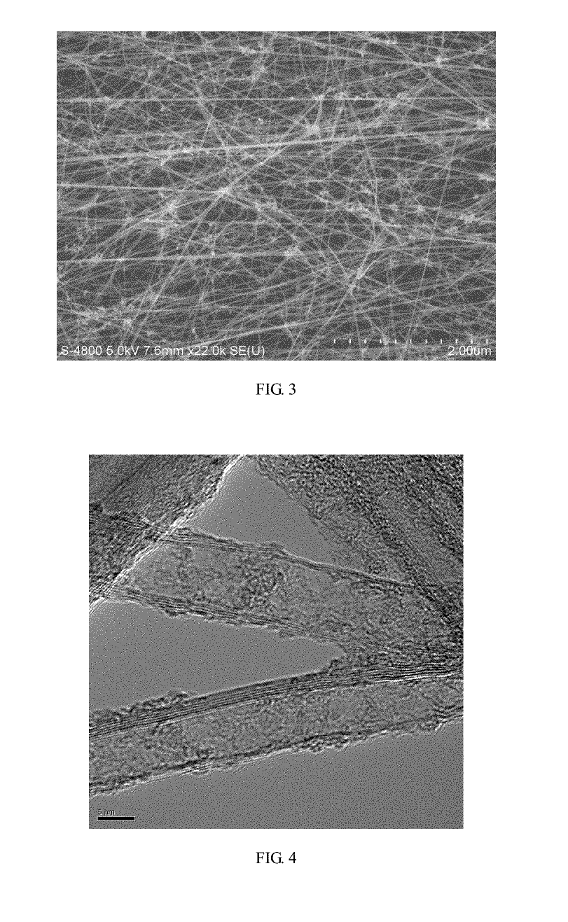

1) a cylindrical hollow carbon nanotube continuum grown in a high-temperature furnace (please refer to P276, Issue 304, 2004, Science) is continuously wound on a cylindrical horizontal roller under the effect of air buoyancy by means of the Vander Wale force between carbon nanotubes, the roller can reciprocate in the axial direction by the distance equal to the length of the roller while rotating, ethyl alcohol is sprayed onto the surface of a continuous carbon nanotube assembly obtained after the carbon nanotube continuum is continuously collected for a certain period of time, and meanwhile, a cylindrical steel roller is used for pressurization at the pressure about 4 MPa (as is shown in FIG. 1). After the solvent is volatilized at the indoor temperature, the continuous carbon nanotube assembly is taken down from the supporting roller, and thus a self-support nanocarbon film (please see FIGS. 2-4 for the morphology of the self-support nanocarbon film) is formed, wherein the thickness of the self-support nanocarbon film is about 7 μm, and the surface density of the self-support nanocarbon film is about 3 g/m².

2) Afterwards, as is shown in FIG. 1, the self-support nanocarbon film obtained in step (1) is pressed through a press to further improve the density of the film, wherein the pressing pressure is 15 MPa, the pressing temperature is about 90° C., and the pressing time is about 2 h. As for the finally obtained nanocarbon impact-resistant material, the average thickness is about 5 um, the average surface density is about 3 g/m², the average tensile strength is about 800 MPa, the average modulus is about 120 GPa, and the average breaking elongation is about 9%.

Second Embodiment: the preparation technique of the nanocarbon impact-resistant material in the second embodiment comprises the following steps:

1) the preparation technique of carbon nanotubes in the first embodiment is taken as the reference, a cylindrical hollow carbon nanotube continuum grown in a high-temperature furnace (please refer to the typical case mentioned above for the preparation technique of the carbon nanotube continuum) is continuously wound on a cylindrical horizontal roller under the effect of air buoyancy by means of the Vander Wale force between the carbon nanotubes, the roller can reciprocate in the axial direction by the distance equal to the length of the roller while rotating, a graphene alcohol solution (the concentration is about 0.1 wt %-5 wt %, and the alcohol solvent in the graphene alcohol solution can be propyl alcohol, ethyl alcohol, ethanediol and the like can also be the mixed solvent of alcohol and water) is sprayed onto the surface of a continuous carbon nanotube assembly obtained after the carbon nanotube continuum is continuously collected for a certain period of time, and meanwhile, a cylindrical steel roller is used for pressurization at the pressure 4 MPa (as is shown in FIG. 1). After the solvent is volatilized at the indoor temperature, the continuous carbon nanotube assembly is taken down from the supporting roller, and thus a self-support nanocarbon film is formed, wherein the thickness of the self-support nanocarbon film is about 12 μm, and the surface density of the self-support nanocarbon film is about 6.5 g/m².

2) The nanocarbon film obtained in step (1) is pressed through a press to further improve the density of the film, wherein the pressing pressure is about 2 MPa, the pressing temperature is about 90° C., and the pressing time is about 4 h. As for the finally obtained nanocarbon impact-resistant material, the average thickness is about 10 μm, the average surface density is about 6.5 g/m², the average tensile strength is about 1200 MPa, the average modulus is about 140 GPa, and the average breaking elongation is about 7%.

Third Embodiment: the preparation technique of the nanocarbon impact-resistant material in the third embodiment comprises the following steps:

1) the preparation technique of carbon nanotubes in the first embodiment is taken as the reference, a cylindrical hollow carbon nanotube continuum grown in a high-temperature furnace (please refer to the first embodiment and the second embodiment) is continuously wound on a cylindrical horizontal roller under the effect of air buoyancy by means of the Vander Wale force between the carbon nanotubes, the roller can reciprocate in the axial direction by the distance equal to the length of the roller while rotating, a graphene polyurethane solution (the concentration is about 0.1 wt %-5 wt %) is sprayed onto the surface of a continuous carbon nanotube assembly obtained after the carbon nanotube continuum is continuously collected for a certain period of time, and meanwhile, a cylindrical steel roller is used for pressurization at the pressure about 4 MPa. After the solvent is volatilized at the indoor temperature, the continuous carbon nanotube assembly is taken down from the supporting roller, and thus a self-support nanocarbon film is formed, wherein the thickness of the self-support nanocarbon film is about 17 μm, and the surface density of the self-support nanocarbon film is about 8 g/m².

2) The nanocarbon film obtained in step (1) is pressed through a press to further improve the density of the film, wherein the pressing pressure is about 90 MPa, the pressing temperature is about 110° C., and the pressing time is about 2 h. As for the finally obtained nanocarbon impact-resistant material, the average thickness is about 13 μm, the average surface density is about 8 g/m², the average tensile strength is about 600 MPa, the average modulus is about 80 GPa, and the average breaking elongation is about 12%.

Fourth Embodiment: the preparation technique of the nanocarbon impact-resistant material in the fourth embodiment comprises the following steps:

1) continuous carbon nanotube continuums are grown under a high-temperature condition through carbon source gas under the effect of metal catalysts (please refer to the second embodiment), and the obtained carbon nanotube continuums are continuously gathered on a two-dimensional plane and arranged in parallel to form a carbon nanotube film, wherein the carbon nanotubes can be any type or the combinations of more than two types of single-wall carbon nanotubes, double-wall carbon nanotubes and multi-wall carbon nanotubes, the tube diameter of the carbon nanotubes is 2-100 nm, and as for the carbon nanotube film formed by the carbon nanotubes bonded together by means of the Vander Wale force, the thickness is about 5-15 um, and the surface density is about 3-7 g/m².

2) The nanocarbon film obtained in step (1) is pressed through a press to further improve the density of the film, wherein the pressing temperature is the indoor temperature, the pressing pressure is about 120 MPa, and the pressing time about 1 h. As for the finally obtained nanocarbon impact-resistant material, the average tensile strength is about 300 MPa, the average modulus is about 130 GPa, and the average breaking elongation is about 12%.

Fifth Embodiment: the preparation technique of the nanocarbon impact-resistant material in the fifth embodiment comprises the following steps:

continuous carbon nanotube continuums are formed through pyrolysis of carbon source gas (please refer to the second embodiment), and a film material is formed through planar winding of a carbon nanotube assembly, wherein as for the film material, the average thickness is about 22 μm, the average surface density is about 6.5 g/m², the average tensile strength is about 3-50 MPa, the average modulus is about 15 GPa, and the average breaking elongation is about 25%.

Sixth Embodiment:

One nanocarbon impact-resistant material obtained in the first embodiment is regarded as a basic unit, and four basic units are stacked in the mode that the orientation angle of the carbon nanotube assembly on the top layer is 0 degree, the orientation angle of the carbon nanotube assembly on the second layer is 90 degrees (namely the orientation angle of the carbon nanotube assembly on the second layer is perpendicular to that of the carbon nanotube assembly on the top layer), the orientation angle of the carbon nanotube assembly on the third layer is 0 degree (namely the orientation angle of the carbon nanotube assembly on the third layer is the same as that of the carbon nanotube assembly on the top layer) and the orientation angle of the carbon nanotube assembly on the bottom layer is 90 degrees (namely the orientation angle of the carbon nanotube assembly on the bottom layer is perpendicular to that of the carbon nanotube assembly on the top layer); and the four basic units are then pressed to form a structure defined as A[0/90/0/90], and the other four basic units are stacked in the similar mode to form a structure defined as B [0/45/90/135].

Over 400 layers of nanocarbon films are stacked in the A/B/A/B mode and then pressed, and thus the nanocarbon impact-resistant material with the composite structure is formed.

Adjacent basic units in the structural layers A and the structural layers B are bonded together with polyurethane binding agents, and each structural layer A and the adjacent structural layer B are also bonded together with polyurethane binding agents.

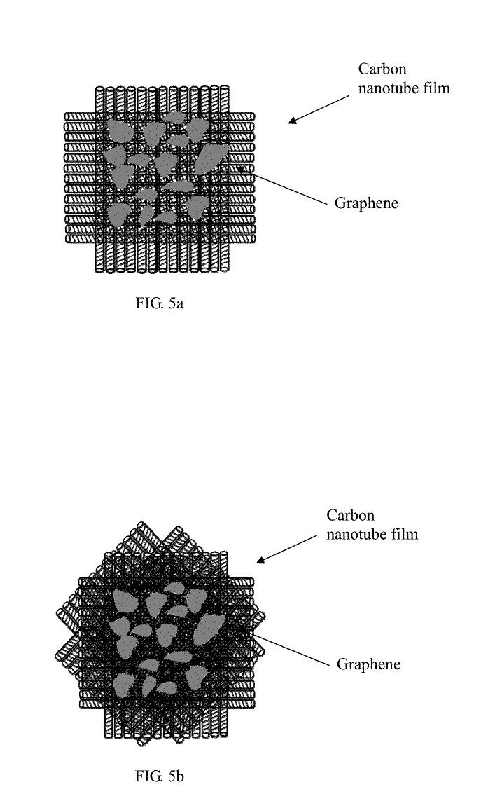

Seventh Embodiment: according to the scheme in the sixth embodiment, a structural layer A[0/90/0/90] and a structural layer B[0/45/90/135] are prepared with one nanocarbon impact-resistant material obtained in the second embodiment as a basic unit (as is shown in FIG. 5a and FIG. 5b), and then the nanocarbon impact-resistant material with the composite structure is prepared.

Eighth Embodiment: according to the scheme in the sixth embodiment, the nanocarbon impact-resistant material with the composite structure is prepared with one nanocarbon impact-resistant material obtained in the third embodiment as a basic unit.

Table 1 shows the performance testing results of the nanocarbon impact-resistant material with the composite structure obtained in the embodiments 6-8.

Ninth Embodiment: a buckypaper-shaped carbon nanotube film is prepared from carbon nanotube powder sold on the market through a filtration method, wherein as for the buckypaper-shaped carbon nanotube film, the thickness is about 40 μm, the surface density is about 12 g/m², the tensile strength is about 10 MPa, the modulus is about 2 GPa, and the breaking elongation is about 3%.

Tenth Embodiment: a spun carbon nanotube array is drawn to form a super-aligned carbon nanotube film, wherein as for the super-aligned carbon nanotube film, the thickness is about 7 μm, the surface density is about 6 g/m², the tensile strength is about 400 MPa, the modulus is about 45 GPa, and the breaking elongation is about 3%.

Eleventh Embodiment:

1) a carbon nanotube film is prepared, specifically, continuous carbon nanotube continuums are grown under a high-temperature condition through carbon source gas under the effect of metal catalysts (please refer to P276, Issue304, 2004, science), and the continuous carbon nanotube continuums are continuously gathered on a two-dimensional plane in parallel to form the carbon nanotube film, wherein the carbon nanotubes can be any type or the combinations of more than two types of single-wall carbon nanotubes, double-wall carbon nanotubes and multi-wall carbon nanotubes, and the tube diameter of the carbon nanotubes is 2-100 nm; the carbon nanotubes are bonded together by means of the Vander Wale force, then the carbon nanotube film is pressed through a press (please see FIG. 1 for the pressing process) to further improve the density of the film, wherein the pressing pressure is 15 MPa, the pressing temperature is 90° C., and the pressing time is 2 h; and as for the finally obtained carbon nanotube film (with the morphology as is shown in FIGS. 2-4), the average surface density is about 5 g/m², the average tensile strength is about 300 MPa, the average modulus is about 60 GPa, and the average breaking elongation is about 10%.

2) UHMWPE unidirectional cloth is prepared, specifically, UHMWPE fibers with the surfaces dipped with glue (with the tensile strength about 22 CN/dtex) are arranged in the plane in parallel to form the unidirectional cloth, and the surface density of the unidirectional cloth is about 40 g/m².

3) The carbon nanotube film obtained in step (1) and one layer of UHMWPE unidirectional cloth are compounded through hot pressing to form a subunit, and the method for hot pressing comprises:

the first stage for which the temperature is 110° C., the pressure is 2 MPa and the time is 10 min;

the second stage for which the temperature is 130° C., the pressure is 25 MPa and the time is 10 min, and then natural cooling is conducted;

4) Four subunits obtained in step (3) are stacked in the 0/90/45/−45 mode (the warp orientation of the unidirectional cloth in the first subunit is set as 0 degree, the warp orientation of the unidirectional cloth in the second subunit is set as 90 degrees, the warp orientation of the unidirectional cloth in the third subunit is set as 45 degrees, the warp orientation of the unidirectional cloth in the fourth subunit is set as −45 degrees, and this is abbreviated as 0/90/45/−45) to form a structural layer.

5) Thirty structural layers are stacked to form a stab-proof structure, and then a dynamic puncture test is conducted.

Twelfth Embodiment:

1) a carbon nanotube film is prepared, specifically, continuous carbon nanotube continuums are grown under a high-temperature condition through carbon source gas under the effect of metal catalysts (please refer to the typical embodiment mentioned above), and the continuous carbon nanotube continuums are continuously gathered on a two-dimensional plane in parallel to form a carbon nanotube film, wherein the carbon nanotubes can be any type or the combinations of more than two types of single-wall carbon nanotubes, double-wall carbon nanotubes and multi-wall carbon nanotubes, and the tube diameter of the carbon nanotubes is 2-100 nm; the carbon nanotubes are bonded together by means of the Vander Wale force, then the carbon nanotube film is pressed through a press to further improve the density of the film, wherein the pressing pressure is 2 MPa, the pressing temperature is 90° C., and the pressing time is about 4 h; and as for the finally obtained carbon nanotube film, the average surface density is about 5.5 g/m², the average tensile strength is about 200 MPa, the average modulus is about 45 Gpa, and the average breaking elongation is about 18%.

2) Aramid fiber unidirectional cloth is prepared, specifically, aramid fibers with the surfaces dipped with glue (with the tensile strength about 22 CN/dtex) are arranged in the plane in parallel to form the unidirectional cloth, and the surface density of the unidirectional cloth is about 110 g/m².

3) The carbon nanotube film obtained in step (1) and the aramid fiber unidirectional cloth are compounded through hot pressing to form a subunit, and the method for hot pressing comprises:

the first stage for which the temperature is 110° C., the pressure is 2 MPa and the time is 10 min;

the second stage for which the temperature is 130° C., the pressure is 25 MPa and the time is 10 min, and then natural cooling is conducted.

4) Four subunits obtained in step (3) are stacked in a 0/90/45/−45 mode (the warp orientation of the unidirectional cloth in the first subunit is set as 0 degree, the warp orientation of the unidirectional cloth in the second subunit is set as 90 degrees, the warp orientation of the unidirectional cloth in the third subunit is set as 45 degrees, the warp orientation of the unidirectional cloth in the fourth subunit is set as −45 degrees, and this is abbreviated as 0/90/45/−45) to form a structural layer;

5) Thirty structural layers are stacked to form a stab-proof structure, and then a dynamic puncture test is conducted.

Thirteenth Embodiment:

1) a carbon nanotube film is prepared, specifically, continuous carbon nanotube continuums are grown under a high-temperature condition through carbon source gas under the effect of metal catalysts (please refer to the twelfth embodiment), and the carbon nanotube continuums are continuously gathered on a two-dimensional plane in parallel to form a carbon nanotube film, wherein the carbon nanotubes can be any type or the combinations of more than two types of single-wall carbon nanotubes, double-wall carbon nanotubes and multi-wall carbon nanotubes, and the tube diameter of the carbon nanotubes is 2-100 nm; the carbon nanotubes are bonded together by means of the Vander Wale force, then the carbon nanotube film is pressed through a press to further improve the density of the film, wherein the pressing temperature is the indoor temperature, the pressing pressure is 120 MPa, and the pressing time is about 1 h; and as for the finally obtained carbon nanotube film, the average surface density is about 5 g/m², the average tensile strength is about 200 MPa, the average modulus is about 45 Gpa, and the average breaking elongation is about 18%.

2) UHMWPE unidirectional cloth is prepared, specifically, UHMWPE fibers with the surfaces dipped with glue are arranged on the plane in parallel to form the unidirectional cloth, and the surface density of the unidirectional cloth is about 40 g/m².

3) The carbon nanotube film obtained in step (1) and one layer of UHMWPE unidirectional cloth are compounded through hot pressing to form a subunit, and the method for hot pressing comprises:

the first stage for which the temperature is 110° C., the pressure is 2 MPa and the time is 10 min;

the second stage for which the temperature is 130° C., the pressure is 25 MPa and the time is 1 min, and then natural cooling is conducted.

4) Four subunits obtained in step (3) are stacked in the 0/45/90/−45 mode to form a structural layer;

5) Ten structural layers are stacked to form a stab-proof structure, and then a dynamic puncture test is conducted.

First Contrast Embodiment: ten UHMWPE units obtained in the eleventh embodiment are stacked for a dynamic test.

Second Contrast Embodiment: eight aramid fiber units obtained in the twelfth embodiment are stacked for a dynamic test.

Fourteenth Embodiment: a buckypaper-shaped carbon nanotube film is prepared from carbon nanotube powder sold on the market through a filtration method, wherein as for the buckypaper-shaped carbon nanotube film, the thickness is about 40 um, the surface density is about 12 g/m², the tensile strength is about 10 MPa, the modulus is about 2 GPa, and the breaking elongation is about 3%. Afterwards, the carbon nanotube film in the eleventh embodiment is replaced with the buckypaper-shaped carbon nanotube film, and according to the scheme in the eleventh embodiment, the buckypaper-shaped carbon nanotube film and the UHMWPE unidirectional cloth are bonded to form the stab-proof composite material. As for the stab-proof composite material, the average surface density is about 170 g/m², and the maximum puncture depth is 50 cm.

Fifteenth Embodiment: a spun carbon nanotube array is drawn to form a super-aligned carbon nanotube film, wherein as for the super-aligned carbon nanotube film, the thickness is about 7 μm, the surface density is about 6 g/m², the tensile strength is about 400 MPa, the modulus is about 45 GPa, and the breaking elongation is about 3%. Afterwards, the carbon nanotube film in the twelfth embodiment is replaced with the super-aligned carbon nanotube film, and according to the scheme in the twelfth embodiment, the super-aligned carbon nanotube film and the aramid fiber unidirectional cloth are bonded to form the stab-proof composite material. As for the stab-proof composite material, the average surface density is about 115 g/m², and the maximum puncture depth is about 18 cm, and the maximum load is about 850N.

Sixteenth Embodiment:

1) a cylindrical hollow carbon nanotube continuum grown in a high-temperature furnace (please refer to P276, Issue 304, 2004, Science) is continuously wound on a cylindrical horizontal roller under the effect of air buoyancy by means of the Vander Wale force between carbon nanotubes, the roller can reciprocate in the axial direction by the distance equal to the length of the roller while rotating, ethyl alcohol is sprayed onto the surface of a continuous carbon nanotube assembly obtained after the carbon nanotube continuum is continuously collected for a certain period of time, and meanwhile, a cylindrical steel roller is used for pressurization at the pressure about 4 MPa (please see FIG. 1 for the process). After the solvent is volatilized at the indoor temperature, the continuous carbon nanotube assembly is taken down from the supporting roller, and thus a self-support nanocarbon film. Afterwards, the self-support nanocarbon film is pressed through a press to further improve the density of the film, wherein the pressing pressure is about 15 MPa, the pressing temperature is about 90° C., and the pressing time is about 2 h. As for the finally obtained carbon nanotube film (with the morphology as is shown in FIGS. 2-4), the average surface density is about 5.5 g/m², the average tensile strength is about 300 MPa, the average modulus is about 60 Gpa, and the average breaking elongation is about 10%, and the carbon nanotube film is marked as M.

2) UHMWPE non-woven cloth is prepared, specifically, each layer of UHMWPE non-woven cloth is formed by four pieces of unidirectional cloth stacked in the 0/90/0/90 mode (defined as mentioned above), the surface density of the UHMWPE non-woven cloth is 120 g/m², and the UHMWPE non-woven cloth is marked as P.

3) The structure is designed, specifically, the upper side and the lower side are each provided with a structure formed by twelve stacked P, and a structure formed by sixty stacked M is located in the middle, and the whole structure is marked as 12P/60M/12P.

4) Cold pressing is conducted, specifically, cold pressing is conducted at the pressure of 8 MPa for 30 min, so that the bullet-proof composite material is obtained, and Table 3 shows the performance testing data of the bullet-proof composite material.

Seventeenth Embodiment:

1) The preparation in the sixteenth embodiment is taken as the reference, a cylindrical hollow carbon nanotube continuum grown in a high-temperature furnace (please refer to the typical case mentioned above for the preparation technique of the carbon nanotube continuum) is continuously wound on a cylindrical horizontal roller under the effect of air buoyancy by means of the Vander Wale force between the carbon nanotubes, the roller can reciprocate in the axial direction by the distance equal to the length of the roller while rotating, a graphene alcohol solution (the concentration is about 0.1 wt %-5 wt %, and the alcohol solvent in the graphene alcohol solution can be propyl alcohol, ethyl alcohol, ethanediol and the like can also be the mixed solvent of alcohol and water) is sprayed onto the surface of a continuous carbon nanotube assembly obtained after the carbon nanotube continuum is continuously collected for a certain period of time, and meanwhile, a cylindrical steel roller is used for pressurization at the pressure about 4 MPa (as is shown in FIG. 1). After the solvent is volatilized at the indoor temperature, the continuous carbon nanotube assembly is taken down from the supporting roller, and thus a self-support nanocarbon film is obtained formed; the nanocarbon tube film is then pressed through a press to further improve the density of the film, wherein the pressing pressure is about 2 MPa, the pressing temperature is about 90° C., and the pressing time is about 4 h. As for the finally obtained carbon nanotube film, the average surface density is about 5.5 g/m², the average tensile strength is about 450 MPa, the average modulus is about 90 GPa, the average breaking elongation is about 7%, and the nanocarbon tube film is marked as M.

2) UHMWPE non-woven cloth is prepared, specifically, each layer of non-woven cloth is formed by four pieces of unidirectional cloth which are stacked in the 0/90/0/90 mode (defined as mentioned above), the surface density of the UHMWPE non-woven cloth is about120 g/m², and the UHMWPE non-woven cloth is marked as P.

3) The structure is designed, specifically, the upper side is provided with a structure formed by seven stacked P, the lower side is provided with a structure formed by seventeen stacked P, a structure formed by sixty stacked M is located in the middle, and the whole structure is marked as 7P/60M/17P.

4) Cold pressing is conducted, specifically, cold pressing is conducted at the pressure of 8 MPa for 30 min, so that the bullet-proof composite material is obtained, and Table 3 shows the performance testing data of the bullet-proof composite material.

Eighteenth Embodiment:

1) Continuous carbon nanotube continuums are grown under a high-temperature condition through carbon source gas under the effect of metal catalysts (please refer to the seventeenth embodiment), and the obtained carbon nanotube continuums are continuously gathered on a two-dimensional plane and arranged in parallel to form a carbon nanotube film, wherein the carbon nanotubes can be any type or the combinations of more than two types of single-wall carbon nanotubes, double-wall carbon nanotubes and multi-wall carbon nanotubes, and the tube diameter of the carbon nanotubes is 2-100 nm. The carbon nanotubes are bonded by means of the Vander Wale force and wound on a plane to form a carbon nanotube film, and the carbon nanotube film is then pressed through a press to further improve the density of the film, wherein the pressing temperature is the indoor temperature, the pressing pressure is about 10 MPa, and the pressing time is about 1 h. As for the finally obtained film, the average surface density is about 5.5 g/m², the average tensile strength is about 200 MPa, the average modulus is about 45 GPa, the average breaking elongation is about 18%, and the film is marked as M.

2) UHMWPE non-woven cloth is prepared, specifically, each layer of UHMWPE non-woven cloth is formed by four pieces of unidirectional cloth stacked in the 0/90/0/90 mode. The surface density of the UHMWPE non-woven cloth is 120 g/m², and the UHMWPE non-woven cloth is marked as P.

3) The structure is designed, specifically, the upper side is provided with a structure formed by seventeen stacked P, the lower side is provided with a structure formed by seven stacked P, a structure formed by sixty stacked M is located in the middle, and the whole structure is marked as 17P/60M/7P.

4) Cold pressing is conducted, specifically, cold pressing is conducted at the pressure of 8 MPa for 30 min, so that the bullet-proof composite material is obtained, and Table 3 shows the performance testing data of the bullet-proof composite material.

Nineteenth Embodiment:

1) Continuums are formed by carbon nanotubes through pyrolysis of carbon source gas, and a film material is formed through planar winding of the assembly. The surface density of the film material is 5.5 g/m², the tensile strength of the film material is 200 MPa, the modulus of the film material is 45 GPa, the breaking elongation of the film material is 18%, and the film material is marked as F.

2) UHMWPE non-woven cloth is prepared, specifically, each layer of UHMWPE non-woven cloth is formed by four pieces of unidirectional cloth stacked in the 0/90/0/90 mode. The surface density of the UHMWPE non-woven cloth is 120 g/m², and the UHMWPE non-woven cloth is marked as P.

3) The structure is designed, specifically, one P and two M are stacked to form a structural unit, and twenty-four structural units are stacked to form a composite structure marked as [1P/2M]24.

4) Cold pressing is conducted, specifically, cold pressing is conducted at the pressure of 8 MPa for 30 min, so that the bullet-proof composite material is obtained, and Table 3 shows the performance testing data of the bullet-proof composite material.

Third Contrast Embodiment: UHMWPE non-woven cloth is prepared, specifically, each layer of UHMWPE non-woven cloth is formed by four pieces of unidirectional cloth stacked in the 0/90/0/90 mode. The surface density of the UHMWPE non-woven cloth is 120 g/m², and the UHMWPE non-woven cloth is marked as P. Twenty-four P are stacked to form the bullet-proof composite material, and Table 3 shows the performance testing data of the formed bullet-proof composite material.

Twentieth Embodiment: a buckypaper-shaped carbon nanotube film is prepared from carbon nanotube powder sold on the market through a filtration method, wherein as for the buckypaper-shaped carbon nanotube film, the thickness is about 40 um, the surface density is about 12 g/m², the tensile strength is about 10 MPa, the modulus is about 2 GPa, and the breaking elongation is about 3%. According to the scheme in the sixteenth embodiment, the buckypaper-shaped carbon nanotube film and the UHMWPE non-woven cloth are bonded to form the bullet-proof composite material. As for the formed bullet-proof composite material, the average surface density is about 125 g/m², the number of penetration layers is about 9, the V50 value is about 510 m/s, and the concave depth is about 22 mm.

Twenty-first Embodiment: a spun carbon nanotube array is drawn to form a super-aligned carbon nanotube film, wherein as for the super-aligned carbon nanotube film, the thickness is about 7 μm, the surface density is about 6 g/m², the tensile strength is about 400 MPa, the modulus is about 45 GPa, and the breaking elongation is about 3%. According to the scheme of the seventeenth embodiment, the super-aligned carbon nanotube film and the UHMWPE non-woven cloth are bonded to form the bullet-proof composite material. As for the formed bullet-proof composite material, the average surface density is about 126 g/m², the number of penetration layers is about 10, the V50 value is about 520 m/s, and the concave depth is about 1 mm.

TABLE 1

| | V50 | thickness | penetration depth |
|---|---|---|---|
| serial number | (m/s) | (mm) | (mm) |
| sixth embodiment | 420 | 6 | 11 |
| seventh | 515 | 8 | 6 |
| embodiment | | | |
| eighth embodiment | 540 | 8 | 0 |

Note: the bullet-proof standard: the bullet-proof test standard for police GA141-2010. The stab-proof: GA-2008.

TABLE 2

| | | | | first | second |
|---|---|---|---|---|---|
| | eleventh | twelfth | thirteenth | contrast | contrast |
| | embodiment | embodiment | embodiment | embodiment | embodiment |
| fiber type | UHMWPE | aramid fiber | UHMWPE | UHMWPE | aramid fiber |
| surface density | 5 | 5 | 5 | — | — |
| of film g/m² | | | | | |
| surface density | 6 | 6 | 6 | 6 | 6 |
| of composite | | | | | |
| material g/m² | | | | | |
| stacking angle | 0/90/45/−45 | 0/90/45/−45 | 0/45/90/−45 | 0/90/45/−45 | 0/90/45/−45 |
| maximum penetration | 12 | 13 | 9 | 43 | 50 |
| depth (cm) | | | | | |
| maximum load (N) | 935 | 900 | 961 | 604 | 581 |

TABLE 3
test result comparison for the embodiments 1-4 and
the product in the first contrast embodiment

| | | | | | third |
|---|---|---|---|---|---|
| | sixteenth | seventeenth | eighteenth | nineteenth | contrast |
| | embodiment | embodiment | embodiment | embodiment | embodiment |
| surface | 3.2 | 3.2 | 3.2 | 3.2 | 3 |
| density g/m² | | | | | |
| number of penetration | 9 | 7 | 7 | 8 | / |
| layers | | | | | |
| V50 value m/s | 533 | 541 | 517 | 533 | 460 |
| concave depth mm | 19 | 19 | 22 | 21 | 20 |

What needs to be pointed out is that the drawings of the application are in an extremely simplified form and an inaccurate proportion and are only used for assisting in conveniently and clearly describing the embodiments of the application. Furthermore, the terms such as ‘comprise’, ‘include’ or other variants all indicate non-exclusive inclusion, so that processes, methods, articles or devices including a series of elements not only include the mentioned elements, but also include other elements which are not clearly listed or include inherent elements of the processes, the methods, the articles or the devices.

It should be understood that the above embodiments are only preferred embodiments of the application and are not used for limiting the application. For those skilled in the field, various modifications and changes of the application can be obtained. Any modifications, equivalent substitutes and improvements made based on the spirit and principle of the application are all within the protection scope of the application.

1. An application of carbon nanotube assemblies to the preparation of a nanocarbon impact-resistant material, characterized in that the carbon nanotube assembly is a macrostructure provided with at least one continuous plane or curved surface, a plurality of carbon nanotubes are densely distributed in the continuous surface, at least partial segments of at least part of the multiple carbon nanotubes continuously extent in the continuous surface,
the carbon nanotube assembly comprising a plurality of basic units which are distributed in an oriented mode, and each basic unit comprises a two-dimensional surface structure which is formed by a plurality of interwoven carbon nanotubes, the multiple basic units are densely distributed in at least one continuous surface in parallel, thus the carbon nanotube assembly is in a macro-ordered form, and the multiple carbon nanotubes in each basic unit are interwoven disorderedly, thus the carbon nanotube assembly is in a micro-disordered form.

2. The application according to claim 1, characterized in that the nanocarbon impact-resistant material is a bullet-proof composite material, and the bullet-proof composite material comprises:
at least one carbon nanotube assembly; and fabric, wherein the surface of at least one side of the fabric is covered with at least one carbon nanotube assembly.

3. (canceled)

4. The application according to claim 1, characterized in that the nanocarbon impact-resistant material is a stab-proof composite material, and the stab-proof composite material comprises:
at least one carbon nanotube assembly; and
soft base cloth, wherein the surface of at least one side of the soft base cloth is covered with at least one carbon nanotube film.

5. (canceled)

6. The application according to claim 1, characterized in that each of at least two carbon nanotube assemblies arranged in a stacked mode are of a two-dimensional surface macrostructure, and at least one carbon nanotube assembly comprises a plurality of basic units which are distributed in an oriented mode in the first direction, the other carbon nanotube assembly comprises a plurality of basic units which are distributed in an oriented mode in the second direction, and the included angle between the first direction and the second direction is 0-180 degrees and is preferably 45-135 degrees.

7-10. (canceled)

11. The application according to claim 7, characterized in that multiple carbon nanotube continuums are continuously deposited on at least one continuous surface and then compacted, so that the multiple basic units are formed, each carbon nanotube continuum is formed by a plurality of interwoven carbon nanotubes and is of a closed, semi-closed or open two-dimensional or three-dimensional spatial structure before being compacted, and the carbon nanotube continuums are prepared through the floating catalytic cracking method.

12-13. (canceled)

14. The application according to claim 7, characterized in that the longitudinal peripheries of every two adjacent basic units can be spaced from each other, or be next to each other or overlap with each other.

15. (canceled)

16. The application according to claim 7, characterized in that every two adjacent carbon nanotube assemblies are directly bonded together; or a binding material layer is further arranged between every two adjacent carbon nanotube assemblies, or shear thickening fluid is injected between every two adjacent carbon nanotube assemblies.

17. The application according to claim 1, characterized in that graphene is further distributed on the surface and/or the interior of the carbon nanotube assembly.

18-19. (canceled)

20. The application according to claim 17, characterized in that the nanocarbon impact-resistant material further comprises the assembly of a plurality of graphene sheets, and at least one carbon nanotube assembly and at least one assembly of multiple graphene sheets are of a two-dimensional surface macrostructure and are arranged in a stacked mode.

21. (canceled)

22. The application according to claim 1, characterized in that the carbon nanotube assembly is provided with a porous structure, the pore diameter of pores of the porous structure is 10 nm-200 nm, and the porosity of the porous structure is 10%-60%, and/or, the tube diameter of the carbon nanotubes is 2-100 nm, and/or, the content of the carbon nanotbues in the carbon nanotube assembly is over 99 wt %.

23. The application according to claim 1, characterized in that at least one carbon nanotube assembly is a self-support carbon nanotube film.

24. The application according to claim 1, characterized in that the nanocarbon impact-resistant material is of a soft filmy or sheet structure on the whole, and/or, the thickness of the nanocarbon impact-resistant material is 1-100 μm and preferably is 5-15 μm, and/or, the surface density of the nanocarbon impact-resistant material is 2-20 g/m² and preferably is 5-10 g/m², and/or, the tensile strength of the nanocarbon impact-resistant material is over 10 MPa, preferably is over 90 Mpa and particularly is over 200 MPa, and the modulus of the nanocarbon impact-resistant material is over 10 GPa, preferably is over 30 Gpa and particularly is over 60 GPa, and/or, the tolerable temperature the nanocarbon impact-resistant material ranges from the liquid nitrogen temperature to 500° C.

25-30. (canceled)

31. The application according to claim 4, characterized in that the stress of the carbon nanotube film is equal to or higher than 10 MPa, the elongation of the carbon nanotube film is equal to or higher than 2%, the absolute value of the difference between the tensile stress in the length direction and the tensile stress in the width direction is smaller than or equal to 20% of the tensile stress in the length direction or in the width direction, and the absolute value of the difference between the breaking elongation in the length direction and the breaking elongation in the width direction is smaller than or equal to 10% of the breaking elongation in the length direction or in the width direction, and/or the thickness of the carbon nanotube film is smaller than or equal to that of the soft base cloth, and/or, the strength of high-performance fibers forming the soft base cloth is equal to or higher than 2.0 GPa, the modulus of the high-performance fibers is equal to or higher than 80 GPa, and the elongation of the high-performance fibers is 3-5%.

32-34. (canceled)

35. The application according to claim 4, characterized in that the soft base cloth and the carbon nanotube assemblies are bonded through hot pressing or binding agents.

36-37. (canceled)

38. The application according to claim 2, characterized in that the carbon nanotube assembly is a carbon nanotube film, the strength of the carbon nanotube film in the orientation direction of the basic units of the carbon nanotube film is 50 MPa-12 GPa and preferably is 120 MPa-1 GPa, and the strength of the carbon nanotube film in the direction perpendicular to the orientation direction of the basic units is 30 MPa-10 GPa and preferably is 60 MPa-800 MPa, and/or the tensile strength of monofilaments of the fabric is over 22 CN/dtex and preferably is over 35 CN/dtex, and/or the surface density of the high-performance fiber fabric is 35-220 g/m² and preferably is 120-160 g/m², and/or, high-performance fibers forming the high-performance fiber fabric can be any type or the combination of more than two types of UHMWPE fibers, aramid fibers and poly-p-phenylene ben-zobisthiazole fibers.

39-41. (canceled)

42. The application according to claim 2, characterized in that the nanocarbon impact-resistant material comprises at least two layers of fabric arranged in a stacked mode and/or at least two carbon nanotube assemblies arranged in a stacked mode, and the carbon nanotube assemblies are filmy.

43. The application according to claim 42, characterized in that at least one carbon nanotube assembly is distributed between every two adjacent layers of fabric, or at least one layer of fabric is distributed between every two adjacent carbon nanotube assemblies.

44. (canceled)

45. The application according to claim 42, characterized in that every two adjacent layers of fabric are both non-woven fabric, and the included angle between the warp orientation direction of one layer of fabric and the warp orientation direction of the other layer of fabric is 0-180 degrees and preferably is 45-135 degrees, or the orientation direction of the basic units in at least one carbon nanotube assembly distributed between every two adjacent layers of fabric is the same as the warp orientation direction of at least one layer of fabric, and the fabric is non-woven fabric.

46. (canceled)

47. The application according to claim 2, characterized in that the carbon nanotube assemblies are attached to the surfaces of the two opposite sides of at least one layer of fabric.

48-52. (canceled)

53. The application according to claim 4, characterized in that a stab-proof structure is prepared from the stab-proof composite materials and comprises N subunits which are arranged in a stacked mode, wherein each subunit comprises the stab-proof composite material and N is an integer multiple of four, then in every two adjacent subunits, the basic units of the carbon nanotube assemblies in one subunit are arranged in an oriented mode in the first direction, the basic units of the carbon nanotube assemblies in the other subunit are arranged in an oriented mode in the second direction, the included angle between the first direction and the second direction is 0-180 degrees and preferably is 45-135 degrees.

54-88. (canceled)
